(19) United States
(12) Patent Application Publication
(10) Pub. No.: US 2015/0049999 A1
(43) Pub. Date: Feb. 19, 2015

(54) ULTRA-LOW LOSS OPTICAL FIBER

(71) Applicants: Samsung Electronics Co., Ltd., Suwon-si Gyeonggi-do (KR); Industry-Academic Cooperation Foundation, Yonsei University, Seoul (KR)

(72) Inventors: Yeong-Seop Lee, Gumi-si (KR); Mun-Hyun Do, Daegu-si (KR); Si-Ho Song, Gumi-si (KR); Dea-Hwan Oh, Gumi-si (KR); Dae-Seung Moon, Gumi-si (KR); Kyung-Hwan Oh, Seongnam-si (KR)

(21) Appl. No.: 14/359,524

(22) PCT Filed: Nov. 22, 2012
(86) PCT No.: PCT/KR2012/009899

§ 371 Date: May 20, 2014

(30) Foreign Application Priority Data
Nov. 24, 2011 (KR) 10-2011-0123527

(51) Int. Cl. G02B 6/028; G02B 6/036

(52) U.S. Cl. CPC G02B 6/0281; G02B 6/036; B29K 2995/0031
USPC 385/124; 65/385

(57) ABSTRACT

An ultra-low loss optical fiber is provided. The ultra-low loss optical fiber includes a core having the maximum refractive index inside an optical fiber, and placed at the central portion of the optical fiber, a trench having the minimum refractive index inside the optical fiber and encompassing the core, and a cladding encompassing the trench. The core includes a first sub-core layer having the maximum refractive index inside the optical fiber, and placed at the center of the optical fiber, a second sub-core layer having a refractive index lower than that of the first sub-core layer and encompassing the first sub-core layer, and a third sub-core layer having a refractive index lower than that of the second sub-core layer and encompassing the second sub-core layer.

### CROSS-REFERENCE TO RELATED APPLICATION(S)

This application is a U.S. National Stage application under 35 U.S.C. §371 of an International application filed on Nov. 22, 2012 and assigned application number PCT/KR2012/009899, which claimed the benefit of a Korean patent application filed on Nov. 24, 2011 in the Korean Intellectual Property Office and assigned Serial number 10-2011-0123527, the entire disclosure of which is hereby incorporated by reference.

### JOINT RESEARCH AGREEMENT

The present disclosure was made by or on behalf of the below listed parties to a joint research agreement. The joint research agreement was in effect on or before the date the present disclosure was made and the present disclosure was made as a result of activities undertaken within the scope of the joint research agreement. The parties to the joint research agreement are 1) SAMSUNG ELECTRONICS CO., LTD. and 2) INDUSTRY-ACADEMIC COOPERATION FOUNDATION, YONSEI UNIVERSITY.

### TECHNICAL FIELD

The present disclosure relates to an optical fiber. More particularly the present disclosure relates to an optical fiber with an ultra-low loss.

### BACKGROUND

Rayleigh scattering refers to a phenomenon in which an optical signal propagating through an optical fiber collides with fine particles in the optical fiber and is scattered. Rayleigh scattering constitutes the largest loss of the optical signal.

A method of reducing the number of particles according to the related art has been used in order to reduce the Rayleigh scattering. In this method, for example, a doped amount of germanium, which is a substance for controlling a refractive index, is reduced, or a substance for decreasing a refractive index is doped into a cladding encompassing a core when the core is formed of pure silica.

In the case that the amount of the germanium doped into the core is reduced, the optical loss caused by the Rayleigh scattering can be reduced. However, there is a problem in that a Mode Field Diameter (MFD) and a zero dispersion wavelength fail to satisfy the G.652.D optical fiber standard.

In the case that the optical fiber has the pure silica core and the cladding is doped with a substance for decreasing the refractive index, during a process of manufacturing a parent material (i.e., a preform) of the optical fiber, it is difficult to perform a sintering due to the pure silica core and the ability to enlarge a diameter of the parent material is limited. Accordingly, there is a problem in that a mass manufacturing of the optical fiber is inappropriate because a flux at which the optical fiber is drawn from the parent material is low. Thus, there is a need for an optical fiber with an ultra-low optical loss, which satisfies the G.652.D optical fiber standard.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an optical fiber with an ultra-low optical loss, which satisfies the G.652.D optical fiber standard.

In accordance with an aspect of the present disclosure, an ultra-low loss optical fiber is provided. The ultra-low loss optical fiber includes a core which is located at a central portion of the optical fiber and has a maximum refractive index in the optical fiber, a trench which encompasses the core and has a minimum refractive index in the optical fiber, and a cladding which encompasses the trench, wherein the core includes a first sub-core layer which is located at a central portion of the optical fiber and has a maximum refractive index in the optical fiber, a second sub-core layer which encompasses the first sub-core layer, and has a refractive index lower than that of the first sub-core layer, and a third sub-core layer which encompasses the second sub-core layer and has a refractive index lower than that of the second sub-core layer.

In accordance with an aspect of the present disclosure, an ultra-low loss optical fiber is provided. The ultra-low loss optical fiber includes a core which is located at a central portion of the optical fiber and has a maximum refractive index in the optical fiber, a trench which encompasses the core and has a minimum refractive index in the optical fiber, and a cladding which encompasses the trench, wherein the core includes a first sub-core layer which is located at a central portion of the optical fiber and has a refractive index lower than a maximum refractive index in the optical fiber, a second sub-core layer which encompasses the first sub-core layer and has the maximum refractive index in the optical fiber, and a third sub-core layer which encompasses the second sub-core layer and has a refractive index lower than that of the second sub-core layer.

The optical fiber according to the present disclosure has advantages in having a characteristic satisfying the G.652.D optical fiber standard, an optical loss reduced more than 10%, and in being suitable for mass-manufacturing.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B are views illustrating an optical fiber according to an embodiment of the present disclosure; and

FIGS. 2A and 2B are views illustrating an optical fiber according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, description of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

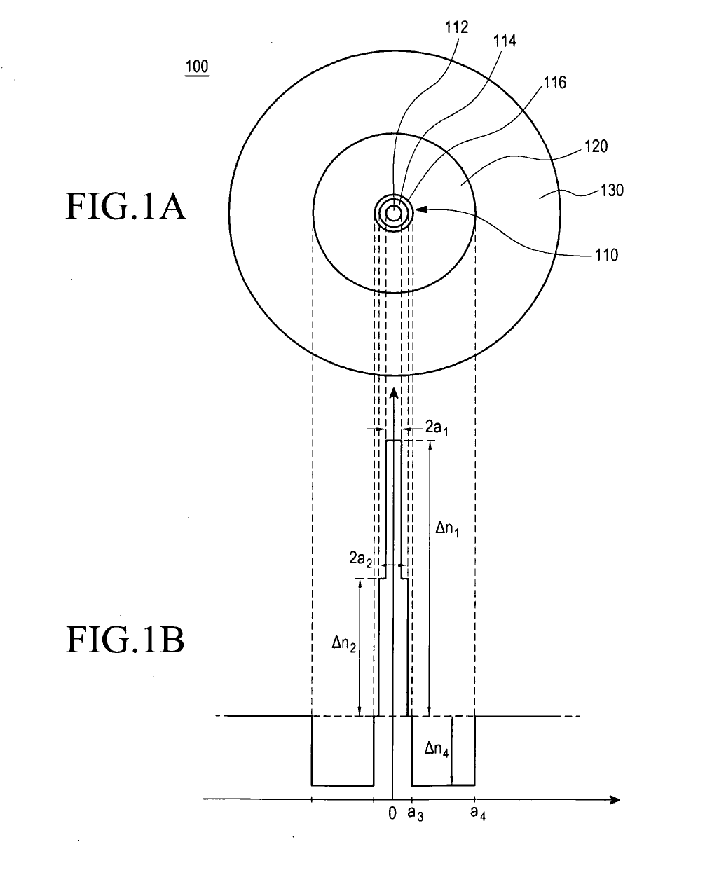

FIGS. 1A and 1B are views illustrating an optical fiber according to an embodiment of the present disclosure. In more detail, FIG. 1A is a sectional view illustrating an optical fiber according to an embodiment of the present disclosure, and FIG. 1B is a graph illustrating a profile of a refraction index according to a section of the optical fiber according to an embodiment of the present disclosure.

Referring to FIGS. 1A and 1B, the optical fiber 100 includes a core 110 with a triple structure, which is located at a central portion of the optical fiber, a trench 120 encompassing the core 110, and a cladding 130 encompassing the trench 120. An optical signal propagates into the core 110 through a total internal reflection.

The core 110 includes a first sub-core layer 112 located at the central portion of the optical fiber 100, and second and third sub-core layers 114 and 116 sequentially laminated on an outer peripheral surface of the first sub-core layer 112. The first sub-core layer 112 has a rod shape with a circular section, and the second and third sub-core layers 114 and 116 have a tube shape with an annular section. The first, second and third sub-core layers 112, 114 and 116 are arranged in a concentric structure.

The first sub-core layer 112 is located at the central portion of the optical fiber 100, and has a maximum refractive index in the optical fiber 100. The first sub-core layer 112 wholly may have a constant refractive index. The first sub-core layer 112 may have a refractive index difference Δn₁ equal to or less than 0.0039, and an outer peripheral radius a₁ equal to or less than 2.7 μm. As an example, the first sub-core layer 112 may have the refractive index difference Δn₁ of 0.0035˜0.0039, and the outer peripheral radius a₁ of 2.3˜2.7 μm. The refractive index difference of each layer constituting the optical fiber 100 may be defined by a difference of the refractive index of each layer and the refractive index of the cladding 130 located at the outermost periphery of the optical fiber 100.

The second sub-core layer 114 is directly laminated on the outer peripheral surface of the first sub-core layer 112, and has a lower refractive index than that of the first sub-core layer 112. The second sub-core layer 114 wholly may have a constant refractive index. The second sub-core layer 114 may have a refractive index difference Δn₂ equal to or less than 0.0022, and an outer peripheral radius a₂ equal to or less than 4.4 μm. For example, the second sub-core layer 114 may have the refractive index difference Δn₂ of 0.0018˜0.0022, and the outer peripheral radius a₂ of 4.0˜4.4 μm.

The third sub-core layer 116 is directly laminated on the outer peripheral surface of the second sub-core layer 114, and the third sub-core layer 116 has a refractive index which is higher than that of the trench 120, but lower than that of the second sub-core layer 114. The third sub-core layer 116 wholly may have a constant refractive index. For example, the third sub-core layer 116 may have the same refractive index as that of the cladding 130, and may be made of pure silica which is not doped with the refractive index control substance. The third sub-core layer 116 may have the outer peripheral radius a₃ equal to or less than 6.2 μm. For example, the third sub-core layer may have the outer peripheral radius a₃ of 5.8˜6.2 μm.

The trench 120 has an annular tube shape, and is arranged to be concentric with the core 110. The trench 120 is directly laminated on the outer peripheral surface of the third sub-core layer 116, and has a minimum refractive index in the optical fiber 100. The trench 120 wholly may have a constant refractive index. The trench 120 may have a refractive index difference Δn₄, and an outer peripheral radius a₄ equal to or less than 32 μm. For example, the trench 120 may have the refractive index difference Δn₄ of −0.0008˜−0.0012, and the outer peripheral radius a₄ of 28˜32 μm.

The cladding 130 is located at the outermost periphery of the optical fiber 100, has an annular tube shape, and is arranged to be concentric with the core 110 and the trench 120. The cladding 130 is directly laminated on the outer peripheral surface of the trench 120, and has a refractive index difference which is higher than that of the trench 120 and lower than or equal to that of the third sub-core layer 116. The cladding 130 wholly may have a constant refractive index. For example, the cladding 130 may be made of pure silica, and may have the same refractive index, e.g., 1.456, as a refractive index of pure silica glass.

As a numeric example, the first sub-core layer 112 may have the refractive index difference Δn₁ of 0.0037 and the outer peripheral radius a₁ of 2.5 μm, the second sub-core layer 114 may have the refractive index difference Δn₂ of 0.0020 and the outer peripheral radius a₂ of 4.2 μm, the third sub-core layer 116 may have the refractive index difference Δn₃ of 0 and the outer peripheral radius a₃ of 6.0 μm, and the trench 120 may have the refractive index difference Δn₄ of −0.0010 and the outer peripheral radius a₄ of 30 μm.

The optical fiber according to the present disclosure may have the triple-core structure of which the central portion protrudes in the refractive index profile, as described above, or may have the triple-core structure of which the central portion is depressed in the refractive index profile, as described later.

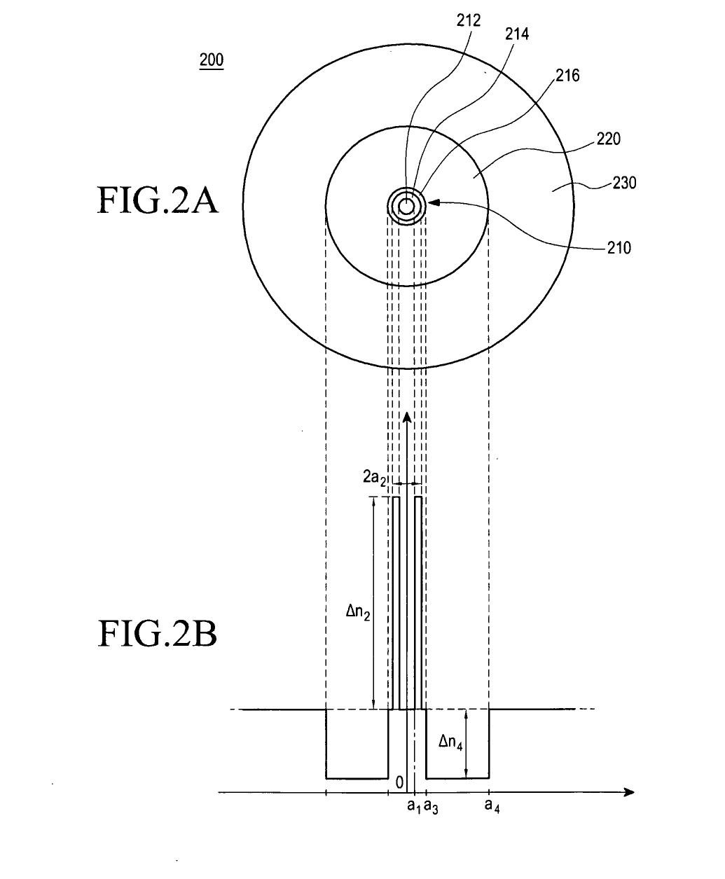

FIGS. 2A and 2B are views illustrating an optical fiber according to an embodiment of the present disclosure. In more detail, FIG. 2A is a sectional view illustrating an optical fiber according to an embodiment of the present disclosure, and FIG. 2B is a graph illustrating a refractive index profile according to the section of the optical fiber according to an embodiment of the present disclosure.

Referring to FIGS. 2A and 2B, the optical fiber 200 includes a triple structural core 210, a trench 220 and a cladding 230. An optical signal propagates into the core 210 through a total internal reflection.

The core 210 includes a first sub-core layer 212 located at the central portion of the optical fiber 200, and second and third sub-core layers 214 and 216 sequentially laminated on an outer peripheral surface of the first sub-core layer 212. The first sub-core layer 212 has a rod shape with a circular section, and the second and third sub-core layers 214 and 216 have an annular tube shape. The first, second and third sub-core layers 212, 214 and 216 are arranged in a concentric structure.

The first sub-core layer 212 is located at a central portion of the optical fiber 200, and has a refractive index which is higher than that of the trench 220, but lower than that of the second sub-core layer 214. The first sub-core layer 212 wholly may have a constant refractive index. For example, the first sub-core layer 212 may have the same refractive index as that of the cladding 230, and may be made of pure silica. The first sub-core layer 212 may have the outer peripheral radius a₁ equal to or less than 1.7 μm. For example, the first sub-core layer 212 may have the outer peripheral radius a₁ of 1.3˜1.7 μm.

The second core layer 214 is directly laminated on the outer peripheral surface of the first sub-core layer 212, and has a maximum refractive index in the optical fiber 200. The second sub-core layer 214 wholly may have a constant refractive index. The second sub-core layer 214 may have a refractive index difference Δn₂ equal to or less than 0.0022, and an outer peripheral radius a₂ equal to or less than 4.4 μm. For example, the second sub-core layer 214 may have the refractive index difference Δn₂ of 0.0018˜0.0022, and the outer peripheral radius a₂ of 4.0˜4.4 μm.

The third sub-core layer 216 is directly laminated on the outer peripheral surface of the second sub-core layer 214, and the third sub-core layer 216 has a refractive index which is higher than that of the trench 220, but lower than that of the second sub-core layer 214. The third sub-core layer 216 wholly may have a constant refractive index. For example, the third sub-core layer 216 may have the same refractive index as that of the cladding 230, and may be made of pure silica. The third sub-core layer 216 may have the outer peripheral radius a₃ equal to or less than 6.2 μm. For example, the third sub-core layer 216 may have the outer peripheral radius a₃ of 5.8˜6.2 μm.

The trench 220 has an annular tube shape, and is arranged to be concentric with the core 210. The trench 220 is directly laminated on the outer peripheral surface of the third sub-core layer 216, and has a minimum refractive index in the optical fiber 200. The trench 220 wholly may have a constant refractive index. The trench 220 may have a refractive index difference Δn₄ equal to or more than −0.0012, and an outer peripheral radius a₄ equal to or less than 32 μm. For example, the trench 220 may have the refractive index difference Δn₄ of −0.0008˜−0.0012, and the outer peripheral radius a₄ of 28˜32 μm.

The cladding 230 is located at the outermost periphery of the optical fiber 200, has an annular tube shape, and is arranged to be concentric with the core 210 and the trench 220. The cladding 230 is directly laminated on the outer peripheral surface of the trench 220, and has a refractive index difference which is higher than that of the trench 220 and lower than or equal to that of the third sub-core layer 216. The cladding 230 wholly may have a constant refractive index. For example, the cladding 230 may be made of pure silica, and may have the same refractive index, e.g., 1.456, as a refractive index of pure silica glass.

As a numeric example, the first sub-core layer 212 may have the refractive index difference Δn₁ of 0 and the outer peripheral radius a₁ of 1.5 μm, the second sub-core layer 214 may have the refractive index difference Δn₂ of 0.0020 and the outer peripheral radius a₂ of 4.2 μm, the third sub-core layer 216 may have the refractive index difference Δn₃ of 0 and the outer peripheral radius a₃ of 6.0 μm, and the trench 220 may have the refractive index difference Δn₄ of −0.0010 and the outer peripheral radius a₄ of 30 μm.

Table 1 indicates characteristics of the optical fibers according to the first and second embodiments of the present disclosure.

TABLE 1

| Item | | First embodiment | Second embodiment |
|---|---|---|---|
| Loss (dB/km) | 1310 nm | 0.298 | 0.286 |
| | 1383 nm | Equal to or less | 0.231 |
| | | than 0.298 | |
| | 1550 nm | 0.177 | 0.177 |

| | | |
|---|---|---|
| MFD@1310 nm [μm] | 9.51 | 12.4 |
| Zero dispersion [nm] | 1322 | 1303.5 |
| Dispersion @1550 nm [ps/(km · | 16.23 | 17.95 |
| nm)] | | |
| Zero-dispersion slope [ps/(nm² · | 0.086 | 0.090 |
| km)] | | |
| Cutoff wavelength [nm] | 1200 | 1304 |

The optical fiber 100 according to the first embodiment has a transfer loss equal to or less than 0.18 dB/km at a wavelength of 1550 nm, and equal to or less than 0.31 dB/km at a wavelength of 1310 nm, and has a transfer loss at a wavelength of 1383 nm, which is equal to or lower than that at a wavelength of 1310 nm. Further, the optical fiber 100 may have a zero-dispersion wavelength of 1300˜1324 nm, a Mode Field Diameter (MFD) of 8.8˜9.6 μm at a wavelength of 1310 nm, a dispersion value equal to or less than 18.0 ps/(km·nm) at a wavelength of 1550 nm, a zero-dispersion slope equal to or less than 0.092 ps/(nm²·km), and a cutoff wavelength equal to or less than 1260 nm.

The optical fiber 200 according to the second embodiment has a transfer loss equal to or less than 0.18 dB/km at a wavelength of 1550 nm, and equal to or less than 0.31 dB/km at a wavelength of 1310 nm, and has a transfer loss at a wavelength of 1383 nm, which is equal to or lower than that at a wavelength of 1310 nm. Further, the optical fiber 200 may have a zero-dispersion wavelength of 1300˜1324 nm, a dispersion value equal to or less than 18.0 ps/(km·nm) at a wavelength of 1550 nm, and a zero-dispersion slope equal to or less than 0.092 ps/(nm²·km).

The optical fiber according to the present disclosure has an advantage in that light propagating into the optical fiber through the core with a triple structure is more confined to the core, and a part of the core is made of silica capable of reducing the Rayleigh scattering, resulting in an improved loss property.

The optical fiber according to the present disclosure has another advantage in that an ultra-low loss can be achieved by the core with the triple structure, and the MFD and zero-dispersion characteristic can be relatively and easily adjusted in the process.

The optical fiber according to the present disclosure has still another advantage in that more light propagates into the core through the trench structure and a characteristic of preventing a macro bending loss is enhanced.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. An ultra-low loss optical fiber comprising:
a core which is located at a central portion of the optical fiber, and has a maximum refractive index in the optical fiber;
a trench which encompasses the core and has a minimum refractive index in the optical fiber; and
a cladding which encompasses the trench,
wherein the core includes:
a first sub-core layer which is located at a central portion of the optical fiber, and has the maximum refractive index in the optical fiber;
a second sub-core layer which encompasses the first sub-core layer, and has a refractive index lower than that of the first sub-core layer; and
a third sub-core layer which encompasses the second sub-core layer, and has a refractive index lower than that of the second sub-core layer.

2. The ultra-low loss optical fiber as claimed in claim 1, wherein the optical fiber has a transfer loss equal to or less than 0.18 dB/km at a wavelength of 1550 nm, and equal to or less than 0.31 dB/km at wavelengths of 1383 nm and 1310 nm.

3. The ultra-low loss optical fiber as claimed in claim 2, wherein the optical fiber has a zero-dispersion wavelength of 1300˜1324 nm, a Mode Field Diameter (MFD) of 8.8˜9.6 μm at a wavelength of 1310 nm, a dispersion value equal to or less than 18.0 ps/(km·nm) at a wavelength of 1550 nm, a zero-dispersion slope equal to or less than 0.092 ps/(nm²·km), and a cutoff wavelength equal to or less than 1260 nm.

4. The ultra-low loss optical fiber as claimed in claim 1, wherein the first sub-core layer has a refractive index difference Δn₁ larger than 0 and equal to or less than 0.0039, and an outer peripheral radius a₁ larger than 0 and equal to or less than 2.7 μm, the second sub-core layer has a refractive index difference Δn₂ larger than 0 and equal to or less than 0.0022, and an outer peripheral radius a₂ larger than 0 and equal to or less than 4.4 μm, the third sub-core layer has an outer peripheral radius a₃ larger than 0 and equal to or less than 6.2 μm, and the trench has a refractive index difference Δn₄ smaller than 0 and equal to or more than −0.0012, and an outer peripheral radius a₄ larger than 0 and equal to or less than 32 μm.

5. The ultra-low loss optical fiber as claimed in claim 4, wherein the optical fiber satisfies conditions in that 0.0035≦Δn₁≦0.0039, 2.3 μm≦a₁≦2.7 μm, 0.0018≦Δn₂≦0.0022, 4.0 μm≦a₂≦4.4 μm, 5.8 μm≦a₃≦6.2 μm, −0.0012≦Δn₄≦−0.0008, and 28 μm≦a₄≦32 μm.

6. An ultra-low loss optical fiber comprising:
a core which is located at a central portion of the optical fiber and has a maximum refractive index in the optical fiber;
a trench which encompasses the core and has a minimum refractive index in the optical fiber; and
a cladding which encompasses the trench,
wherein the core includes:
a first sub-core layer which is located at a central portion of the optical fiber and has a refractive index lower than the maximum refractive index in the optical fiber;
a second sub-core layer which encompasses the first sub-core layer and has the maximum refractive index in the optical fiber; and
a third sub-core layer which encompasses the second sub-core layer and has a refractive index lower than that of the second sub-core layer.

7. The ultra-low loss optical fiber as claimed in claim 6, wherein the optical fiber has a transfer loss equal to or less than 0.18 dB/km at a wavelength of 1550 nm, and equal to or less than 0.31 dB/km at wavelengths of 1383 nm and 1310 nm.

8. The ultra-low loss optical fiber as claimed in claim 7, wherein the optical fiber has a zero-dispersion wavelength of 1300˜1324 nm, a dispersion value equal to or less than 18.0 ps/(km·nm) at a wavelength of 1550 nm, and a zero-dispersion slope equal to or less than 0.092 ps/(nm²·km).

9. The ultra-low loss optical fiber as claimed in claim 6, wherein the first sub-core layer has an outer peripheral radius a₁ larger than 0 and equal to or less than 1.7 μm, the second sub-core layer has a refractive index difference Δn₂ larger than 0 and equal to or less than 0.0022, and an outer peripheral radius a₂ larger than 0 and equal to or less than 4.4 μm, the third sub-core layer has an outer peripheral radius a₃ larger than 0 and equal to or less than 6.2 μm, and the trench has a refractive index difference Δn₄ smaller than 0 and equal to or more than −0.0012, and an outer peripheral radius a₄ larger than 0 and equal to or less than 32 μm.

10. The ultra-low loss optical fiber as claimed in claim 9, wherein the optical fiber satisfies conditions in that 1.3 μm≦a₁≦1.7 μm, 0.0018≦Δn₂≦0.0022, 4.0 μm≦a₂≦4.4 μm, 5.8 μm≦a₃≦6.2 μm, −0.0012≦Δn₄≦−0.0008, and 28 μm≦a₄≦32 μm.

11. A method of making an ultra-low loss optical fiber, the method comprising:
forming a core which is located at a central portion of the optical fiber, and has a maximum refractive index in the optical fiber;
forming a trench which encompasses the core and has a minimum refractive index in the optical fiber; and
forming a cladding which encompasses the trench,
wherein the forming of the core includes:
forming a first sub-core layer which is located at a central portion of the optical fiber, and has the maximum refractive index in the optical fiber;
forming a second sub-core layer which encompasses the first sub-core layer, and has a refractive index lower than that of the first sub-core layer; and
forming a third sub-core layer which encompasses the second sub-core layer, and has a refractive index lower than that of the second sub-core layer.

12. The method according to claim 11, wherein the optical fiber is formed to have a transfer loss equal to or less than 0.18 dB/km at a wavelength of 1550 nm, and equal to or less than 0.31 dB/km at wavelengths of 1383 nm and 1310 nm.

13. The method according to claim 12, wherein the optical fiber is formed to have a zero-dispersion wavelength of 1300˜1324 nm, a Mode Field Diameter (MFD) of 8.8˜9.6 μm at a wavelength of 1310 nm, a dispersion value equal to or less than 18.0 ps/(km·nm) at a wavelength of 1550 nm, a zero-dispersion slope equal to or less than 0.092 ps/(nm²·km), and a cutoff wavelength equal to or less than 1260 nm.

14. The method according to claim 11, wherein the first sub-core layer is formed to have a refractive index difference Δn₁ larger than 0 and equal to or less than 0.0039, and an outer peripheral radius a₁ larger than 0 and equal to or less than 2.7 μm, the second sub-core layer is formed to have a refractive index difference Δn₂ larger than 0 and equal to or less than 0.0022, and an outer peripheral radius a₂ larger than 0 and equal to or less than 4.4 μm, the third sub-core layer is formed to have an outer peripheral radius a₃ larger than 0 and equal to or less than 6.2 μm, and the trench is formed to have a refractive index difference Δn₄ smaller than 0 and equal to or more than −0.0012, and an outer peripheral radius a₄ larger than 0 and equal to or less than 32 μm.

15. The method according to claim 14, wherein the optical fiber is formed to satisfy conditions in that 0.0035≦Δn₁≦0.0039, 2.3 μm≦a₁≦2.7 μm, 0.0018≦Δn₂≦0.0022, 4.0 μm≦a₂≦4.4 μm, 5.8 μm≦a₃≦6.2 μm, −0.0012≦Δn₄≦−0.0008, and 28 μm≦a₄≦32 μm.

16. A method of forming an ultra-low loss optical fiber, the method comprising:
forming a core which is located at a central portion of the optical fiber and has a maximum refractive index in the optical fiber;
forming a trench which encompasses the core and has a minimum refractive index in the optical fiber; and
forming a cladding which encompasses the trench,
wherein the forming of the core includes:
forming a first sub-core layer which is located at a central portion of the optical fiber and has a refractive index lower than the maximum refractive index in the optical fiber;
forming a second sub-core layer which encompasses the first sub-core layer and has the maximum refractive index in the optical fiber; and
forming a third sub-core layer which encompasses the second sub-core layer and has a refractive index lower than that of the second sub-core layer.

17. The method according to claim 16, wherein the optical fiber is formed to have a transfer loss equal to or less than 0.18 dB/km at a wavelength of 1550 nm, and equal to or less than 0.31 dB/km at wavelengths of 1383 nm and 1310 nm.

18. The method according to claim 17, wherein the optical fiber is formed to have a zero-dispersion wavelength of 1300˜1324 nm, a dispersion value equal to or less than 18.0 ps/(km·nm) at a wavelength of 1550 nm, and a zero-dispersion slope equal to or less than 0.092 ps/(nm²·km).

19. The method according to claim 16, wherein the first sub-core layer is formed to have an outer peripheral radius a₁ larger than 0 and equal to or less than 1.7 μm, the second sub-core layer is formed to have a refractive index difference Δn₂ larger than 0 and equal to or less than 0.0022, and an outer peripheral radius a₂ larger than 0 and equal to or less than 4.4 μm, the third sub-core layer is formed to have an outer peripheral radius a₃ larger than 0 and equal to or less than 6.2 μm, and the trench is formed to have a refractive index difference Δn₄ smaller than 0 and equal to or more than −0.0012, and an outer peripheral radius a₄ larger than 0 and equal to or less than 32 μm.

20. The method according to claim 19, wherein the optical fiber is formed to satisfy conditions in that 1.3 μm≦a₁≦1.7 μm, 0.0018≦Δn₂≦0.0022, 4.0 μm≦a₂≦4.4 μm, 5.8 μm≦a₃≦6.2 μm, −0.0012≦Δn₄≦−0.0008, and 28 μm≦a₄≦32 μm.
